(19) United States
(12) Patent Application Publication
(10) Pub. No.: US 2023/0077978 A1
(43) Pub. Date: Mar. 16, 2023

(54) LASER PLOTTER AND METHOD FOR OPERATING A LASER PLOTTER

(71) Applicant: Trotec Laser GmbH, Marchtrenk (AT)

(72) Inventor: Ronald Wögerbauer, Thalheim bei Wels (AT)

(21) Appl. No.: 17/797,836

(22) PCT Filed: Feb. 3, 2021
(86) PCT No.: PCT/AT2021/060039

§ 371 Date: Aug. 5, 2022

(30) Foreign Application Priority Data
Feb. 12, 2020 (AT) A50102/2020

(51) Int. Cl. B23K 26/08; B23K 26/142; B23K 26/16; B23K 26/38; B23K 26/70; B23K 37/04

(52) U.S. Cl. CPC B23K 26/0876; B23K 26/16; B23K 26/38; B23K 26/142; B23K 26/702; B23K 37/0461; B23K 2101/007

(57) ABSTRACT

Described are a method and laser plotter for processing a job for cutting, engraving, marking and/or lettering a flat workpiece having at least one housing with a processing chamber formed for positioning a workpiece. The chamber has at least one irradiation source in the form of a laser and a control unit for controlling the sledge, which may be operated via a belt drive and has a focusing unit arranged movably thereon. Between the sledge and a processing surface of the processing chamber, an extraction bar is arranged for extracting the exhaust gases or vapors, respectively, produced by a laser beam during the processing of the workpiece. One or more extraction openings of the extraction bar are arranged or aligned, respectively, parallel to the processing surface for generating a horizontal extraction flow.

### PRIORITY CLAIM

This application is a U.S. National Stage filing of International Application No. PCT/AT2021/060039, filed Feb. 3, 2021, titled “ LASER PLOTTER AND METHOD FOR OPERATING A LASER PLOTTER”, which claims the benefit of priority to the Austrian Application No. A50102/2020, filed Feb. 12, 2020. All of the aforementioned applications are incorporated herein by reference in their entireties.

### BACKGROUND

Various embodiments relate to a method and laser plotter for processing a job for cutting, engraving, marking and/or lettering a possibly flat workpiece having at least one housing with a processing chamber formed for positioning a workpiece, wherein the chamber has at least one irradiation source in the form of a laser and a control unit for controlling the sledge, which is possibly operated via a belt drive and has a focusing unit arranged movably thereon, as described in claims 1 to 10.

Flatbed laser systems equipped with a belt-driven sledge, on which a focusing unit can be moved as well, are known from the prior art. In certain embodiments, here flat workpieces such as paper, sheets, textiles, etc. are processed using a laser, in particular a laser beam. In order to extract the exhaust gases or vapors, respectively, generated during the processing, extraction devices are arranged on the sledge. Here, an extraction hose is arranged in the area of the focusing unit.

The disadvantage here is that when an extraction hose is used on the focusing unit, this restricts the mobility, in particular the travel speed of the focusing unit with the extraction hose attached.

Another disadvantage is that the extraction channel and the processing head are heavily contaminated when extraction is applied directly to the processing head. Furthermore, if the extraction hose is arranged directly on the focusing unit, the gases and particles with high temperatures may enter the extraction hose directly, resulting in an increased risk of fire.

Certain embodiments create a laser plotter and a method in which, on the one hand, the above-mentioned disadvantages are avoided and, on the other hand, the extraction performance is improved.

Various embodiments disclosed herein achieve this improved performance.

### SUMMARY

In various embodiments, improvements are achieved by a flatbed laser plotter in which an extraction bar is arranged between the sledge and a processing surface of the processing chamber for extracting the exhaust gases or vapors, respectively, produced by a laser beam during the processing of the workpiece, wherein one or more extraction openings of the extraction bar are arranged or aligned, respectively, parallel to the processing surface for generating a horizontal extraction flow.

The advantage here is that the vertically rising smoke or exhaust gases, respectively, are sucked in via the horizontal exhaust gas flow and can then be easily transported on to an extraction system. Due to the positioning of the extraction bar, the same can be optimally aligned underneath the sledge to achieve the best possible extraction performance. At the same time, a splash protection for the optical elements of the focusing unit or the laser head, respectively, in particular the lens, will be created with a correspondingly strong extraction flow, so that the focusing unit or the laser head, respectively, can be built with a simpler and more cost-effective design.

A horizontal extraction flow furthermore has the advantage that the smoke or exhaust gases, respectively, generated by the laser beam are directed towards the extraction bar already as they arise, so that the operator always has a clear view of the workpiece, which is not the case when extraction from above is used, as is known from the prior art. This also reduces the risk of fire, as the hot exhaust gases first rise upwards and are then drawn into the exhaust duct via the horizontal exhaust gas flow, whereby a corresponding cooling is achieved. Furthermore, the exhaust duct is possibly made of metal, so that fire or melting of the material, as is possible with exhaust hoses, is excluded. Another advantage concerns maintenance, as such an exhaust duct can be cleaned more easily, since lateral maintenance openings are provided.

In an advantageous embodiment, the extraction bar is formed L-shaped. This allows a simple and cost-efficient design. Furthermore, this allows the extraction openings to be optimally positioned close to the point of origin of the exhaust gases or smoke, respectively, below the sledge. Another advantage is that a uniform extraction flow can be generated over the entire workpiece, whereby turbulence is avoided. For this purpose, it is possible to determine the workpiece width via sensors so that the exhaust gas flow is then formed accordingly by activating the necessary exhaust gas openings.

In an advantageous embodiment, the extraction bar is attached to the sledge. This means that it is always moved along with the sledge, without requiring any measures to this end. Thus, it does not matter whether processing takes place in the front or rear area of the processing chamber. In addition, the extraction power can be formed to cover the entire processing chamber.

In another advantageous embodiment, however, the extraction openings are formed by several bores or one or more channels, in particular longitudinal channels, or electronically controllable valves, positioned to generate the extraction flow aligned parallel to the processing table. This means that various extraction bars with different extraction openings can be used depending on the area of application or the materials to be processed, respectively. In this case, it is advantageous to have the extraction bar attached to the sledge so that it can be exchanged.

In an advantageous embodiment, the extraction openings are divided into one or more segments that are activated depending on the position of the focusing unit on the sledge. On the one hand, this allows reducing the extraction power, since the exhaust gas flow does not have to be generated continuously over the entire processing width, but is only built up in the area where the focusing unit or the laser head, respectively, is located.

In another advantageous embodiment, an extraction cap is arranged on the focusing unit or on the laser head, respectively, for controlling the extraction flow. This makes it possible to influence the extraction flow by simple means. In particular, this reduces the cross-section between the lower edge of the extraction cap and the surface of the workpiece, whereby the extraction speed in this area is automatically increased.

However, various improvements are achieved also by a method in which a horizontal extraction flow (22) is generated by an extraction bar (20) between the sledge (11), in particular the focusing unit (12) or laser head, respectively, and a processing table (7).

The advantage here is that, on the one hand, an optimum positioning of the exhaust below the sledge is possible and, on the other hand, splash protection for the optical elements on the focusing unit or the laser head, respectively, is created at the same time by the horizontal exhaust gas flow.

Advantageous embodiments are such in which the extraction bar is divided into one or more segments and one or more segments are activated depending on the position of the focusing unit. This ensures that an exhaust gas flow is generated only in the area where flue gases or exhaust gases, respectively, are actually produced, thus ensuring optimum adaptation and safety. Furthermore, this ensures that the highest possible extraction performance is achieved, even in the area immediately after processing. Depending on the material and the machining process, gases can be released in this area even after immediate processing.

Finally, advantageous embodiments are such in which an extraction cap is attached to the laser head or focusing unit, respectively, for controlling an extraction flow. This means that by replacing the extraction cap, a wide range of different conditions for the exhaust gas flow can be taken into account without having to modify the extraction bar. Thus, the extraction flow can be adjusted quickly and easily via the extraction cap. Especially in the case of materials with high smoke generation, an exhaust cap can thus be used that, on the one hand, forms a kind of shut-off and, on the other hand, increases the extraction flow.

An exemplary embodiment are described hereinafter, wherein attention is drawn to the fact that the embodiments are not limited to the exemplary embodiment or solution, respectively, represented, and described.

### BRIEF DESCRIPTION OF THE DRAWINGS

The figures show:

FIG. 1 depicts a schematic illustration of a laser plotter for processing a workpiece with horizontally aligned extraction device.

FIG. 2 depits a schematic illustration of the details of the sledge area with the extraction device.

FIG. 3 depicts a detailed section in the area of the focusing unit with cut L-shaped extraction bar.

FIGS. 4 and 5 show an embodiment in which an extraction cap is attached to a laser head or a focusing unit.

### DETAILED DESCRIPTION

It should be stated by way of introduction that, in the individual embodiments, the same parts are provided with the same reference numbers or same component designations, respectively, wherein the disclosures contained in the entire description can, by analogy, be transferred to identical parts with identical reference numbers or identical component designations, respectively. The position details selected in the description, such as, e.g., top, bottom, lateral, etc. likewise relate to the figure described, and in the event of a change of position, they are to be transferred to the new position by analogy. Individual features or feature combinations from the exemplary embodiments shown and described may also constitute independent inventive solutions.

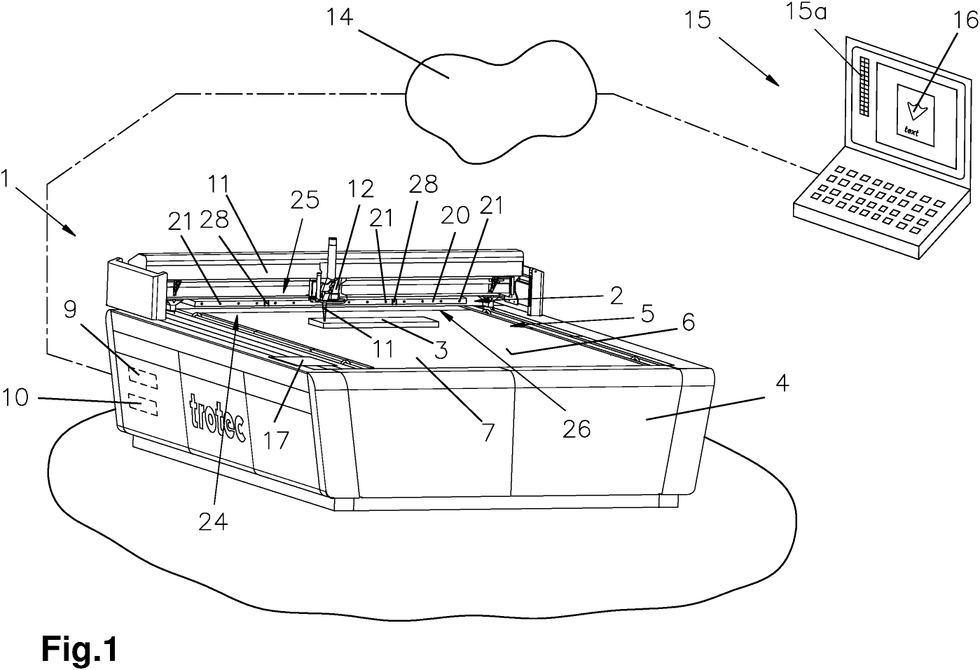

FIGS. 1 to 3 show a laser plotter 1 with an extraction device 2 for processing workpieces 3, wherein the laser plotter 1 is designed to process a job for cutting, engraving, marking and/or lettering the possibly flat workpiece 3.

The laser plotter 1 has a housing 4 in which all elements, such as drives, electronics, laser source, etc. are integrated, so that the laser plotter 1 can be operated as a stand-alone device. In this case, the laser plotter 1 has at least one processing chamber 5 for positioning the workpiece 3 on a processing surface 6 of a processing table 7. Furthermore, the laser plotter 1 has at least one irradiation source in the form of a laser 9 and a control unit 10 for controlling the sledge 11, which is operated possibly via a belt drive, with a focusing unit 12 arranged movably thereon.

For the sake of completeness, it is pointed out that the laser plotter 1 is or can be, respectively, equipped with connections or lines, respectively, for power supply or for connection to the intranet and/or internet 14, as shown schematically. Here, it is possible that the connection with external components 15, such as a laptop or computer 15a, respectively, an automatic feeding unit, a conveyor belt, a sampling robot, etc. can be established by interfaces or cables directly or via the intranet and/or internet 14, in particular a cloud, or via WLan or Bluetooth, respectively, so that data for processing the workpiece 3 can be transmitted from the external components 15, in particular the laptop 15a. In the embodiment of the stand-alone device according to FIG. 1, manual insertion and removal of the workpiece 3 is carried out by an operator on the processing table 7 in the processing chamber 8, wherein a processing job 16, such as that created on the computer 15a, is subsequently started on the laser plotter 1 via an operating unit 17. A detailed description of the function of the laser plotter 1, as well as the processing of the workpiece 3, is waived, since for this purpose such laser plotters 1 are already known from the prior art. It is merely pointed out that it is a laser plotter 1 for processing so-called jobs 16 for cutting, engraving, marking and/or lettering a possibly flat blank 3, in particular a workpiece 3. Here, the laser plotter 1 is used for workpiece thicknesses of up to 50 mm. In certain embodiments, paper, plates, textiles are processed as workpieces 4 or blanks 7, respectively. An essential feature of such laser plotters 1 is that they have a processing chamber 8 in which a sledge 11 operated by a belt drive and having a focusing unit 12 or laser head, respectively, arranged movable thereon is moved or traversed, respectively. For this purpose, a laser beam 18 is directed from the irradiation source 9, in particular the laser 9, as shown schematically, via deflecting elements (not shown) to the focusing unit 12, from which the laser beam 18 is deflected and focused in the direction of the workpiece 3, so that the blank 3 or workpiece 3, respectively, is processed in accordance with the job 16 loaded into a controller 10. Since during the processing of the individual materials by the laser beam 18 exhaust gases or vapors, respectively, in particular smoke 19, are produced during the vaporization of material, as shown schematically in FIG. 3, it is necessary for the laser plotter 1 to have an extraction device 2 that is arranged in the area of the focusing unit 12 and thus any vapors 19 or smoke 19, respectively, which are produced are directly exhausted so that no unpleasant or dangerous odors can be inhaled by the operator.

According to some embodiments, it is now provided that between the sledge 11 and the processing surface 6 of the processing chamber 8 an extraction bar 20 is arranged for extracting the exhaust gases or vapors, respectively, 19 produced by the laser beam 18 during the processing of the workpiece 4, wherein one or more extraction openings 21 of the extraction bar 20 is or are, respectively, arranged or aligned parallel, respectively, to the processing surface 6 or to the processing table 7, respectively, for generating a horizontal extraction flow 22 (as shown by arrows).

In certain embodiments, the extraction bar 20 is formed L-shaped, as can be seen in FIG. 3, wherein it is attached to the sledge 11, in particular on the opposite side to the focusing unit 12 or the laser head 12, respectively. This causes the generated exhaust gas flow 22 to be generated below the sledge 11 and subsequently deflected on the rear side of the sledge 11, i.e. on the opposite side to the focusing unit 12 or the laser head 12, respectively, in such a way that it is deflected in the direction of the sledge 11, i.e. upwards, where the extraction flow 22 will be discharged by an exhaust system (not shown). Of course, it is also possible for the extraction bar 20 to have a multi-part, in particular L-shaped, design.

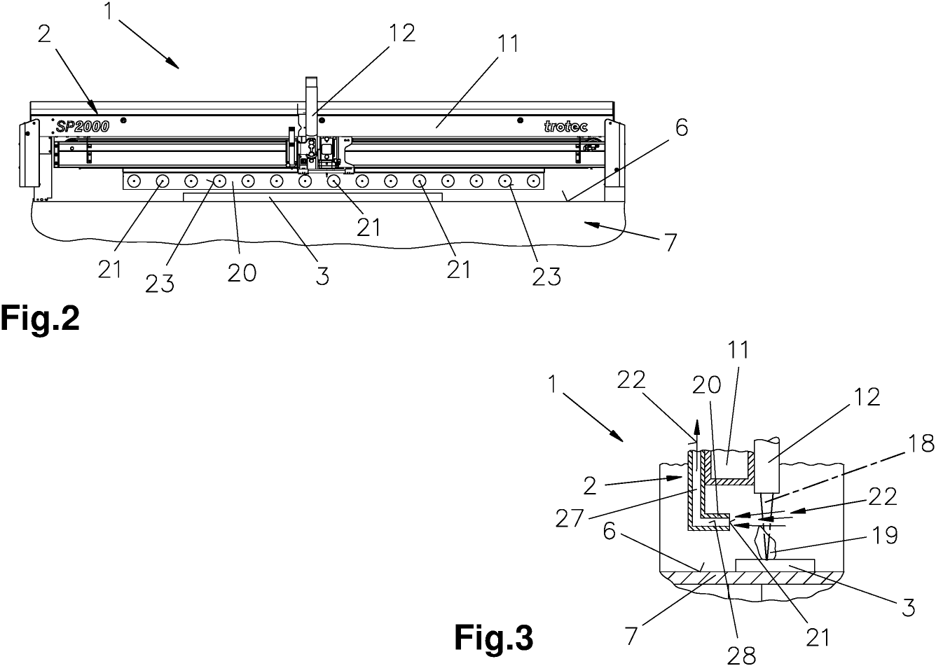

In this respect, it is essential in the extraction device according to some embodiments that an exhaust gas flow 19 generated in parallel direction, i.e. horizontally, to the processing table 7 or the processing surface 6, respectively, is created or generated, respectively, so that the vertically rising smoke 19 or the exhaust gases 19, respectively, are sucked into the exhaust gas bar 20 by the exhaust gas flow 19 and transported away, whereby no dangerous exhaust gases 19 can be inhaled by an operator in the vicinity of the focusing unit 12 or the laser head 12, respectively. In order to generate an optimum horizontal extraction flow 19, the extraction openings 21 can be designed in a wide variety of ways. Here it is possible, on the one hand, to use purely manual openings, in particular one or more holes, as shown in FIG. 1, or one or more channels, as shown in FIG. 3, or, on the other hand, to use electronically controllable openings, such as an electronically controllable valve 23, as shown in FIG. 2, wherein in the case of electronically controllable valves 23, these are connected to the controller 10 and are activated accordingly, wherein not all valves 23 are always activated at the same time, but rather these are activated depending on the position of the focusing unit 12 or laser head 12, respectively. This means that an exhaust gas flow 22 is always generated in that area where the workpiece 3 is currently being processed by the laser beam 18, and thus corresponding exhaust gases 19 or smoke 19, respectively, are being produced.

Here it is advantageous that the extraction openings 21 are divided into one or more segments that are activated depending on the position of the focusing unit 12 on the sledge 11. In this case, the extraction bar 20 can be formed in two or more segments 24 to 26, for example in three segments 24 to 26, namely a left-hand segment 24, a middle segment 25 and a right-hand segment 26, for which purpose the inner discharge channel 27 of the extraction bar 20 is sub-divided by corresponding partition walls 28 and the individual segments can be connected independently of one another to an extraction system, in particular an extraction compressor (not shown). Thus, depending on the position of the focusing unit 12 or the laser head 12, respectively, the closest or matching, respectively, segment 24 to 26 can be activated. This has the advantage that low extraction power is required for this purpose, since it is not necessary for the entire extraction bar 20 to generate an extraction flow 22 over the entire processing width of the laser plotter 1 all the time, but only in that area where the laser head 12 or the focusing unit 12, respectively, is currently located. If the focusing unit 12 or laser head, respectively, changes from one segment, for example the middle segment 25, to another area, for example to the left-hand segment 24, the left-hand segment 24 is activated early so that a smooth transition is ensured.

Of course, it is possible to use any number of segments 24 to 26. Similarly, when electronically controllable extraction openings 21, in particular valves 23, are used, the control is carried out in which, for example, a presettable number of valves 23 to be activated can be set, whereby the exhaust gas flow 22 is generated over a certain width. If the laser head 12 or the focusing unit 12, respectively, is moved to the right or left during the processing of a processing job 16, always the corresponding valves 23 are activated by the control unit 10.

Furthermore, the special design of the horizontal exhaust gas flow 22 ensures that, with a correspondingly high exhaust gas output, splash protection for the optics on the focusing unit 12 or the laser head 12, respectively, is also achieved at the same time as the flue gases 19 or vapors 19, respectively, are extracted, whereby the maintenance cycle for the optics is significantly prolonged, since smoke 19 no longer reaches the optics.

According to some embodiments, the laser plotter 1 carries out a method for operating the laser plotter 1 for processing possibly flat workpieces 3 for a job 16 to be processed for cutting, engraving, marking and/or lettering a workpiece 3 or blank 3, respectively, in which at least one irradiation source in the form of a laser 9 is used in a housing 4 of the laser plotter 1, which acts on the workpiece 3 to be processed, wherein the workpiece 3 is deposited in a defined manner in the processing chamber 8 and a laser beam 18 emitted by the irradiation source is sent via deflecting elements to a focusing unit 12 or to the laser head 12, respectively, from which the laser beam 18 is deflected in the direction of the workpiece 3 and focused for processing, wherein in particular the position control of the workpiece 3 is provided by a control unit 10, in particular a software running in the control unit 10, so that the workpiece 3 is possibly processed line by line by moving of the sledge 11 via possibly a belt drive in the X-Y direction, and in that possibly on an external component 15, in particular a computer 15a or a control unit, a graphic and/or a text is generated via a commercially available software, such as for example CorelDRAW, Paint, etc., which is transferred to the control unit 10 of the laser plotter 1 and is processed by the control unit 10 in the form of one or more jobs 16, wherein a horizontal extraction flow 22 is generated by an extraction bar 20 between the sledge 11, in particular the focusing unit 12 or laser head 12, respectively, and a processing table 7.

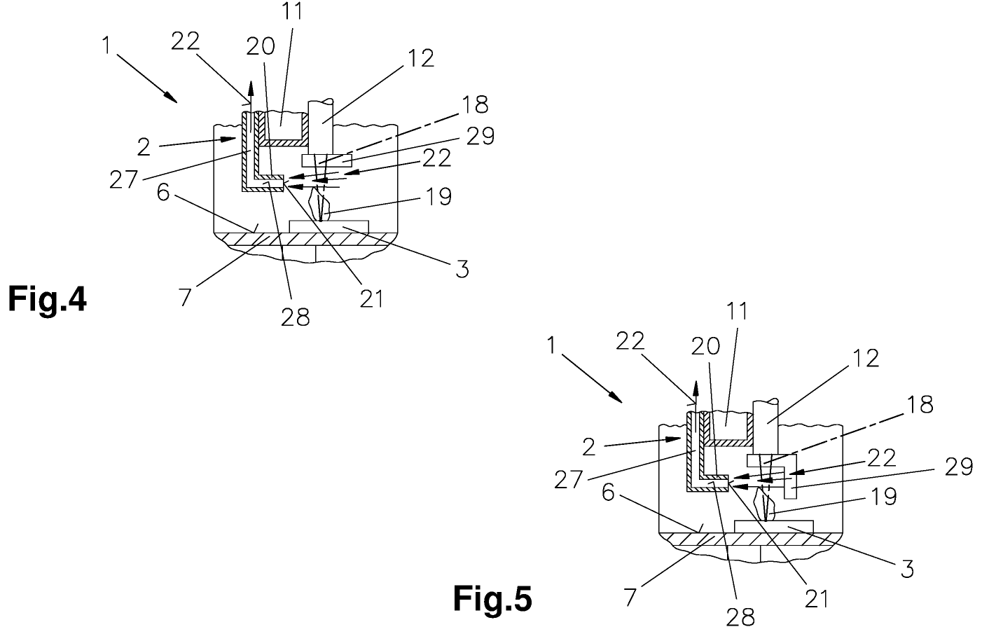

Furthermore, FIGS. 4 and 5 show an embodiment in which an extraction cap 29 is attached to the laser head 12 or the focusing unit 12, respectively, to control the extraction flow 22. According to FIG. 4, the use of the extraction cap reduces the cross-section between the surface of the workpiece 3 and the extraction cap 29, whereby a higher flow velocity below the extraction cap 29 results.

Furthermore, it is also possible for the extraction cap 29 to have a special shape, such as shown in FIG. 5, in order to achieve even better extraction performance in the area of the laser head 12 or the focusing unit 12, respectively. For this purpose, the extraction cap 29 is formed L-shaped, for example, wherein the lower edge of the extraction cap 29 ends with the lower edge of the extraction bar 20, whereby it is ensured that the sledge 11 can travel over the workpiece 3. The special L-shaped design of the extraction cap 29 also ensures that the extraction flow 22 is increased below the focusing unit 12 or the laser head 12, respectively.

As a matter of form, it should finally be emphasized that, for the better understanding of the structure of the engraving workflow 1 and its components or constituent parts, respectively, the same have in part been represented not to scale and/or enlarged and/or reduced in size, and above all only schematically.

What is claimed is:

1. A laser plotter for processing a job for cutting, engraving, marking and/or lettering a flat workpiece having at least one housing with a processing chamber formed for positioning a workpiece, wherein this chamber has at least one irradiation source in the form of a laser and a control unit for controlling the sledge, which is operated via a belt drive, with a focusing unit arranged movably thereon, and wherein arranged between the sledge and a processing surface of the processing chamber there is an extraction bar for extracting the exhaust gases or vapors, respectively, produced during the processing of the workpiece by a laser beam, wherein one or more extraction openings of the extraction bar are arranged or aligned, respectively, parallel to the processing surface for generating a horizontal extraction flow.

2. The laser plotter according to claim 1, wherein the extraction bar is formed L-shaped.

3. The laser plotter according to claim 1, wherein the extraction bar is attached to the sledge.

4. The laser plotter according to claim 3, wherein the extraction openings are formed by a plurality of bores or one or more longitudinal channels, or electronically controllable valves, which are positioned to generate the extraction flow aligned parallel to the processing table.

5. The laser plotter according to claim 1, wherein the extraction openings are divided into one or more segments that are activated depending on the position of the focusing unit on the sledge.

6. The laser plotter according to claim 1, wherein an extraction cap is arranged on the focusing unit or on the laser head, respectively, for controlling the extraction flow.

7. A method for operating a flatbed laser plotter for processing flat workpieces for a job to be processed for cutting, engraving, marking and/or lettering a workpiece or a blank, respectively, in which at least one irradiation source in the form of a laser is used in a housing of the laser plotter, which acts on the workpiece to be processed, wherein the workpiece is deposited in a defined manner in a processing chamber and a laser beam emitted by the irradiation source is sent via deflecting elements to a focusing unit or laser head, respectively, by which the laser beam is deflected in the direction of the workpiece and focused for processing, wherein the position control of the workpiece is provided by a control unit such that the workpiece is processed, line by line, by moving of a sedge via a belt drive in the X-Y direction, and in that on an external component, which is transferred to the control unit of the laser plotter and is processed by the control unit in the form of one or more jobs, wherein a horizontal extraction flow is generated by an extraction bar between the sledge and a processing table.

8. The method according to claim 6, wherein the extraction bar is divided into one or more segments and one or more segments are activated depending on the position of the focusing unit.

9. The method to claim 6, wherein an extraction cap is attached to the laser head or the focusing unit, respectively, for controlling an extraction flow.
